(19) United States
(12) Patent Application Publication
(10) Pub. No.: US 2002/0010647 A1
(43) Pub. Date: Jan. 24, 2002

(54) Hierarchical operation method for a cyber shopping mall

(76) Inventor: Ki Yeol Kim, Seoul (KR)

Correspondence Address: HARNESS, DICKEY & PIERCE, PLC, P.O. BOX 828, BLOOMFIELD HILLS, MI, 48303, US

(21) Appl. No.: 09/887,949

(22) Filed: Jun. 22, 2001

(30) Foreign Application Priority Data
Jul. 19, 2000 (KR) 2000-41393

(51) Int. Cl. G06F 17/60

(52) U.S. Cl. 705/26; 705/14

(57) ABSTRACT

1. Technical field the invention disclosed in claims pertains to

The present invention relates to a method for operating a cyber shopping mall in the internet and a computer-readable recording medium of storing programs for realizing the method.

2. Technical subject the invention tends to solve

It is an object of the present invention to provide a hierarchical operation method for a cyber shopping mall and a computer-readable recording medium of storing programs for realizing the method, in order to easily performs connections, data sharing, and separation among cyber shops by allowing the cyber shops to have a hierarchical (dependent or vertical) structure rather than a horizontal (lateral) structure in installing the cyber shops in the cyber shopping mall.

3. Gist in a solution method of the invention

The present invention, in a hierarchical operation method for a cyber shopping mall applied to an information communication system, is characterized in that cyber shops are hierarchically connected and produced upon opening the cyber shops in the cyber shopping mall.

4. Important use of the invention

The present invention is used for information communication systems and the like.

### BACKGROUND OF THE INVENTION

1. Field of the Invention

The present invention relates to a method for operating a cyber shopping mall in the internet and a computer-readable recording method of storing programs for realizing the method.

2. Reference to Related Patents Applications

U.S. Pat. No. 5,970,469 System and method for providing shopping aids and incentives to customers through a computer network

U.S. Pat. No. 5,890,137 On-line shopping system and the method of payment settlement

U.S. Pat. No. 5,732,400 System and method for a risk-based purchase of goods

U.S. Pat. No. 5,715,314 Network sales system

### DESCRIPTION OF RELATED ART

The internet is widely used in recent, which consists of plural computers and a computer network through a communication link. The interconnected computers can exchange information by using diverse internet services such as electronic mails, gopher, file transfer project (FTP), and World Wide Web (WWW). The WWW services is to transfer to remote client systems information prepared in HyperText Markup Language (HTML) by a server computer system, that is, a web server.

Uniform Resource Locators are given to web resources such as computers and web pages respectively. If a client system requires a transfer according to the HyperText Transfer Protocol by designating a corresponding web page URL, a server system accordingly transfers corresponding web page information to the client system. Therefore, the client system receives the web page and displays it on a monitor through a web browser.

As stated above, diverse services such as cyber logistics services (electronic commerce businesses, auctions), cyber financial services (stocks, banking), cyber education services, and the like are provided by using the internet. In a conventional cyber shopping mall using the internet, cyber shops are operated in a horizontal structure as shown in FIG. 2, so there exists a problem in managements.

FIG. 2 is a view for showing cyber shops in a horizontal structure in a conventional cyber shopping mall.

As shown in FIG. 2, the production of cyber shops in a conventional cyber shopping mall are limited to a horizontal structure. Therefore, there exists a problem in that, upon operating the cyber shops, policies to settlement methods or members can not be operated according to the characteristics of the cyber shops so they have to follow the method of the cyber shopping mall.

Accordingly, there exists a problem in that independent operation methods can not be introduced for the cyber shops themselves as well as members data can not be shared.

Further, there exists a problem in that it is difficult to share data (goods information) as to the cyber shops belonging to one mall and speed is also lowered. Furthermore, in administering the cyber shops, there exists a problem in that the increase of the number of shops causes cyber shopping mall administrators and administration fees to increase.

### SUMMARY OF THE INVENTION

The present invention has been devised to solve the above problems, so it is an object of the present invention to provide a hierarchical operation method for a cyber shopping mall capable of facilitating the connections and data sharing and separation among cyber shops by causing the respective cyber shops to have a hierarchical (dependent or vertical) structure rather than a horizontal (lateral) structure and a computer-readable recording medium of storing programs for realizing the method.

In order to achieve the above object, the present invention is, in a hierarchical operation method for a cyber shopping mall which is applied to an information communication system, characterized by hierarchically connecting and producing cyber shops upon opening the cyber shops in the cyber shopping mall.

Further, the present invention, in a hierarchical operation method for a cyber shopping mall which is applied to an information communication system, comprises steps of (1) building in a cyber shopping mall server meta data for operating the cyber shopping mall such as cyber shop classification criteria, requirements by field, code-granting methods, database-constructing methods, and the like; (2) receiving, by the cyber shopping mall server, cyber shop opening application information in the cyber shopping mall from users who wish to operate cyber shops; (3) selecting, by the cyber shopping mall server, hierarchical categories to which the cyber shops belong by using the cyber shop opening application information and existing shop information based on classification criteria defined by the meta data; (4) granting, by the cyber shopping mall server, codes to the cyber shops and interconnecting upper and lower layers through databases with reference to the meta data based on the hierarchical classification of the cyber shops selected; and (5) notifying, by the cyber shopping mall server, the users of the operations of the cyber shops applied for opening by the users by utilizing the cyber shop information of lower and upper layers interconnecting the cyber shops and the databases.

Furthermore, the present invention, in an information communication system having a processor, provides a computer-readable recording medium of storing programs for realizing functions of (1) receiving cyber shop opening application information in a cyber shopping mall from users who wish to operate cyber shops; (2) selecting hierarchical categories to which the cyber shops belong by using the cyber shop opening application information and existing shop information based on classification criteria defined by meta data for operating the cyber shopping mall; (3) granting codes to the cyber shops and interconnecting upper and lower layers through databases with reference to the meta data based on the hierarchical categories of the cyber shops selected; and (4) notifying the users of the operations of the cyber shops applied for opening by the users by utilizing the cyber shop information of lower and upper layers interconnecting the cyber shops and the databases

### BRIEF DESCRIPTION OF THE DRAWINGS

The above object and other advantages of the present invention will become more apparent by describing in detail a preferred embodiment thereof with reference to the attached drawings, in which:

FIG. 1 is a view for showing a structure of an information communication system according to an embodiment of the present invention;

FIG. 2 is a view for showing cyber shops having a horizontal structure in a conventional cyber shopping mall;

FIG. 3 is a view for showing a hierarchical operation method of a cyber shopping mall according to an embodiment of the present invention; and

FIG. 4 is a flow chart for showing a hierarchical operation method of a cyber shopping mall according to an embodiment of the present invention.

### DETAILED DESCRIPTION OF THE PREFERRED EMBODIMENT

The present invention, in a cyber shopping mall operation method in the internet, is characterized by hierarchically connecting and producing cyber shops when opening the cyber shops in the cyber shopping mall.

That is, by hierarchically (vertically or in multiple levels) connecting cyber shops open in the cyber shopping mall for operations in case of operating a cyber shopping mall in the internet according to the present invention, the cyber shops are easily operated and managed, and settlement methods, members management methods, or the like can be set according to the characteristics of the respective cyber shops.

The above object, characteristics, and advantages will become more apparent through a following detailed description related to the attached drawings. Hereinafter, a preferred embodiment of the present invention will be described in detail.

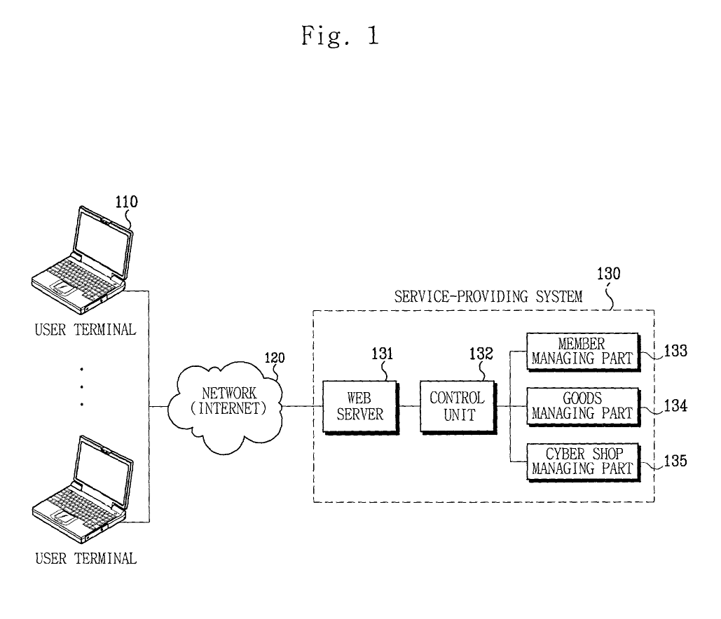

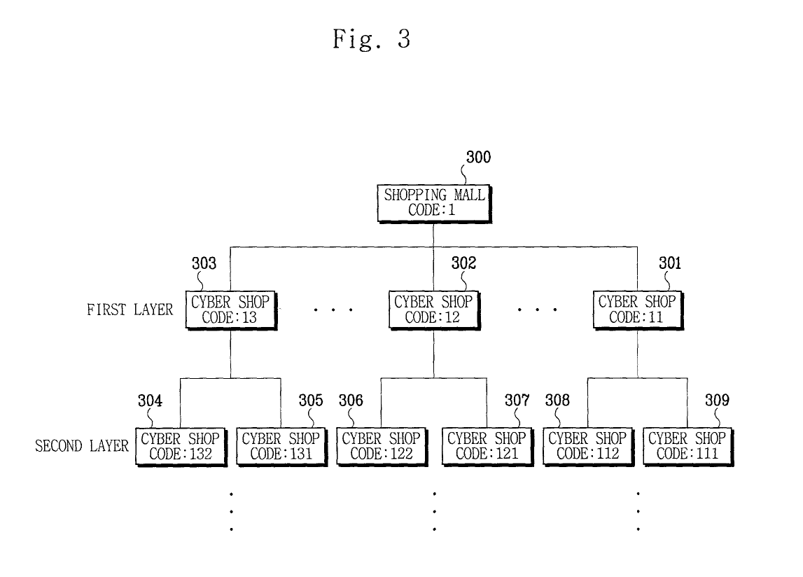

FIG. 1 is a view for showing a structure of an information communication system according to an embodiment of the present invention, and FIG. 3 is a view for showing a hierarchical operation method of a cyber shopping mall according to an embodiment of the present invention.

That is, as shown in FIG. 1, a general information communication system according to an embodiment of the present invention includes a user terminal 110, a network 120 such as the internet, and a service-providing system 130.

At this time, the user terminal 110 is a personal computer (PC) for an electronic commerce business in which at least a web browser is built and an electronic wallet for payments or an electronic commerce business program can be built from necessity.

Meanwhile, wire/wireless communication devices such as personal digital assistants (PDAs), notebooks, cellular phones, and the like, in addition to the personal computers can be employed for user terminals which are used in the electronic commerce business.

The service-providing system 130 includes a web server 131 connected to users through the network 120, a member management part 133 for managing members, a goods managing part 134 for managing goods information, a cyber shop managing part 135 for managing cyber shops hierarchically operated, and a control part 132 for controlling and processing data between the respective parts 133, 134, and 135, and the web server 131. Hereinafter, the service-providing system 130 is referred to as a cyber shopping mall having plural hierarchical cyber shops.

Cyber shop administrators connect to the cyber shopping mall 130 and apply for the openings of cyber shops to a cyber shopping mall administrator. Further, if the cyber shops are opened in the cyber shopping mall 130, the cyber shops can be operated.

The cyber shopping mall 130 provides services for electronic commerce business, and plural independent cyber shops can be opened in the cyber shopping mall 130.

The cyber shopping mall 130 is managed by cyber shopping mall administrators, and each cyber shop can be operated by a cyber shop administrator under managements of the cyber shopping mall administrators.

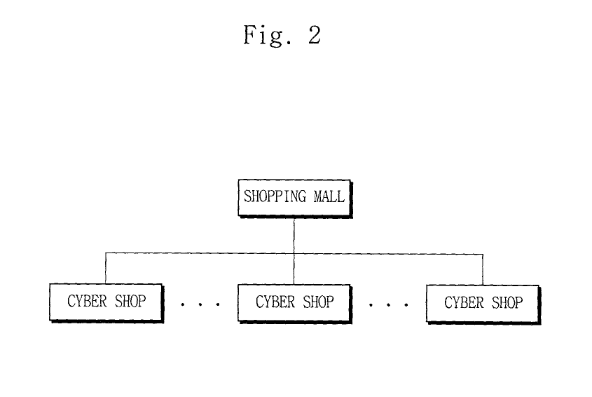

At this time, each of the cyber shops in the cyber shopping mall, as shown in FIG. 2, is generally operated in a horizontal fashion, but, in the present invention, operated in a hierarchical (vertical) fashion as shown in FIG. 3.

That is, as shown in FIG. 3, the cyber shops 301 to 309 includes the cyber shops 301 to 303 of a first layer each of which is connected to lower cyber shops 304 to 309, placing the cyber shopping mall 300, which is a gate mall, at the top of them.

As stated above, the cyber shops connected to the first layer become ones of a second layer, and, even though not shown in drawings, each cyber shop in the second layer can have other cyber shops in its lower layer. The number of lower-layer cyber shops which can belong to one upper-layer cyber shop is at least larger than one to be plural.

Cyber shops hierarchically constructed as stated above only manage other cyber shops hierarchically connected, including themselves, so as to facilitate managements and operations with more ease and enable an operation method of each cyber shop to be set by unit cyber shop rather than by entire shopping mall unit.

In particular, upon granting and connecting vertical authorizations, there is no need to integrate the managements of an entire cyber shopping mall, and the managements can be separated by function so that its operation becomes easy, to thereby enable an operation of a large-scale shopping mall.

Further, each cyber shop can use various methods in payments, member managements, goods exhibitions, and so on, to thereby enable the management of customers according to the cyber shop characteristics. Furthermore, upon producing a cyber shop, upper-layer shops and lower-layer shops are managed as codes rather than a table, so that a searching job for each cyber shop can be facilitated.

That is, diverse categories according to the kinds of goods with which cyber shops deal are classified, layered in hierarchy, and granted codes according to a certain rule, so that customers can find out a cyber shop dealing with goods they wish more easily.

Further, in managing each cyber shop, it is easy to manage cyber shops since one cyber shop manages only itself and other cyber shops belonging to itself, and goods registered in a lower layer than itself can be displayed by dragging them easily from an upper-layer cyber shop when registering the belonging goods since shops are linked among them.

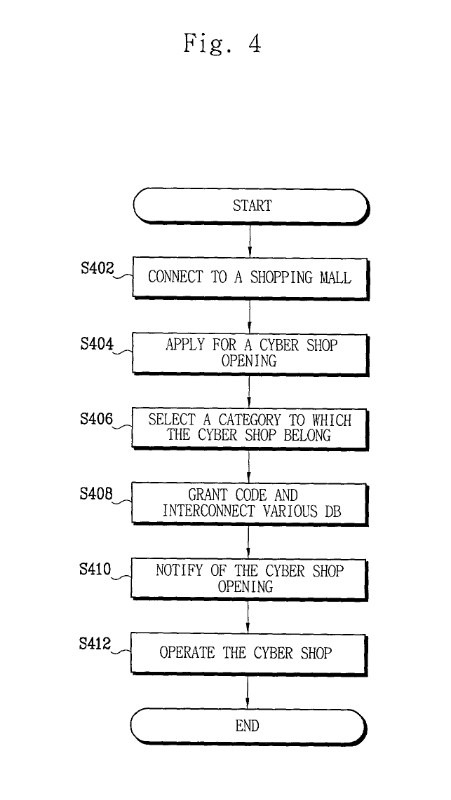

FIG. 4 is a flow chart for showing a hierarchical operation method of a cyber shopping mall according to an embodiment of the present invention.

In order for a hierarchical operation of a cyber shopping mall according to the present invention, cyber shops to be operated in the cyber shopping mall, as shown in FIG. 3, are distinguished into a few large fields 301, 302, and 303. Further, each cyber shop are granted distinct codes for managements. In FIG. 3, codes (1), (11), (12), (13), and so on, are assigned with respect to the respective cyber shops.

At this time, a person who wish to operate a cyber shop in the cyber shopping mall (hereinafter, simply referred to as “cyber shop operator”) first connects to the shopping mall 130, and then applies for the opening of a cyber shop (S404).

A cyber shopping mall administrator checks application items of the cyber shop operator and selects a category to which the cyber shop belongs (S406).

If the category to which the cyber shop belongs are set, a code is assigned to the cyber shop, various databases are interconnected with cyber shops in upper- and lower-layers, and information on the cyber shops is stored in the cyber shop management part 135 for managements (S408).

If the steps are finished, the cyber shopping mall notifies the cyber shop operator of the opening of the cyber shop in the name of the cyber shopping mall administrator (S410). The cyber shop operator notified can share for use the member management part 133 and the goods management part 134 with respect to member information and goods information the cyber shops of upper- and lower-layers which have category codes assigned to themselves have already built (S412).

The above steps will be described in detail with reference to FIG. 3 with a case that a cyber shop operator who wishes to sell goods as to soccer items applies for the opening of a cyber shop.

First of all, it is assumed that the cyber shopping mall (code number 1) consists of a sports goods corner (code number 11), a child goods corner (code number 12), and a lady goods corner (code number 13).

The cyber shopping mall receives an application for the opening of a cyber shop from a cyber shop operator (S402 and S404).

A cyber shopping mall administrator selects a category to which the cyber shop belongs (S406). In this case, the cyber shop will be classified into a sports goods corner of a lower-layer because of the cyber shop which wishes to sell goods as to the soccer items. The category of the cyber shop is notified to an operator of the cyber shop so that the operator can directly process it, or the cyber shopping mall can classify the cyber shop by grasping the application contents.

If the category to which the cyber shop belongs is selected, a code number is assigned for a corresponding category (S408). If a baseball goods corner (code number 111) has been already assigned in a lower layer of the sports goods corner (code number 11), a code number of 112 can be assigned for the soccer goods corner.

As stated above, after the category and code number to which the cyber shop belongs, the cyber shop operator receives an opening notice from the cyber shopping mall (S410). Thus, the cyber shop operator can operate the cyber shop (S412). At this time, the cyber shop operator who operates the soccer goods corner (code number 112) can utilize members information and goods information already built in the member managing part 133 and the goods managing part 134 in the sports goods corner (code number 11) of the upper layer.

However, the cyber shop operator can not utilize the members information and the goods information built in the baseball goods corner (code number 111) horizontally classified.

That is, between cyber shops hierarchically (vertically) classified by code number, for example, between the sports goods corner (code number 11) and the soccer goods corner (code number 112), or between the sports goods corner (code number 11) and the baseball goods corner (code number 111), various databases can be shared, but between cyber shops horizontally classified by the code number, for example, between the soccer goods corner (code number 112) and the baseball goods corner (code number 111), the various databases can not be shared.

Likewise, if a soccer shoes corner (code number 1121) is opened in a lower layer of the soccer goods corner, databases of the soccer shoes corner can be shared.

That is, the operations and managements of a cyber shopping mall can be facilitated by enabling various databases to be shared among cyber shops constructed hierarchically as stated above.

Various pieces of information for hierarchically constructing, classifying by field, granting code numbers to cyber shops, constructing databases, and so on, are put to be systematically processed by using meta data ready in advance in the cyber shopping mall, so that the cyber shopping mall and cyber shops as stated above can be smoothly operated.

The present invention as stated above, in case of administering a cyber shopping mall in the internet, can facilitate the operations and managements of cyber shops by hierarchically (vertically) connecting the cyber shops open in the cyber shopping mall, and set a payment method, a member management method, or the like according to the characteristics of each cyber shop, so that the present invention has an excellent effect in securing much more customer.

Further, the present invention, since there is nothing but managing cyber shops hierarchically connected with themselves in the hierarchically constructed cyber shops, has an excellent effect in that the operations and managements become more simplified.

Further, the present invention has an effect in that the operations of each of cyber shops open in the internet cyber shopping mall can be set by unit cyber shop rather than by entire shopping mall unit.

Further, the present invention has an effect in that entire cyber shops are easily operated so as to enable a large-scale shopping mall to be administered since, upon granting and connecting vertical authorizations, there is no need to integrate and manage entire cyber shops and the entire cyber shops can be separated by function.

Further, the present invention has an effect in that customers can be managed according to the characteristics of cyber shops since each of the cyber shops can use diverse payment methods, member management methods, goods exhibition methods, and so on, in one cyber shopping mall.

Further, the present invention has an effect in that searches for each cyber shop can be facilitated by managing shops of lower- and upper-layers by codes rather than a table upon producing cyber shops. That is, the present invention has an effect in more easily finding out cyber shops dealing with goods that customers wish by classifying the cyber shops into diverse categories according to the kinds of goods being handled, layering them, and granting codes according to a certain rule.

Further, the present invention has an effect in that managements of cyber shops become facilitated since one cyber shop manages only itself and other cyber shops belonging to lower-layers of itself, and one cyber shop can exhibit goods by easily dragging it from cyber shops of an upper-layer with respect to the goods registered in a lower layer of itself upon registering belonging goods since shops are interlinked.

Although the preferred embodiment of the present invention has been described, it will be understood by those skilled in the art that the present invention should not be limited to the described preferred embodiment and the attached drawings, but various replacements, changes, and modifications can be made within the spirit and scope of the present invention as defined by the appended claims.

What is claimed is:

1. A hierarchical operation method for a cyber shopping mall, which is applied to an information communication system, characterized by hierarchically connecting cyber shops upon opening the cyber shops in the cyber shopping mall.

2. The hierarchical operation method as claimed in claim 1, wherein the cyber shopping mall grants certain codes to and hierarchically manages the cyber shops according to categories of goods and services with which the cyber shops deal, to thereby facilitate cyber shop searches.

3. The hierarchical operation method as claimed in claim 1, wherein, in the cyber shops, upper-layer cyber shops can use goods information of lower-layer cyber shops and deal with corresponding goods.

4. The hierarchical operation method as claimed in claim 2, wherein, in the cyber shops, upper-layer cyber shops can use goods information of lower-layer cyber shops and deal with corresponding goods.

5. A hierarchical operation method for a cyber shopping mall, which is applied to an information communication system, comprising steps of:
(1) building in a cyber shopping mall server meta data for operating the cyber shopping mall such as cyber shop classification criteria, requirements by field, code-granting methods, database-constructing methods, and the like;
(2) receiving, by the cyber shopping mall server, cyber shop opening application information in the cyber shopping mall from users who wish to operate cyber shops;
(3) selecting, by the cyber shopping mall server, hierarchical categories to which the cyber shops belong by using the cyber shop opening application information and existing shop information based on classification criteria defined by the meta data;
(4) granting, by the cyber shopping mall server, codes to the cyber shops and interconnecting upper and lower layers through databases with reference to the meta data based on the hierarchical classification of the cyber shops selected; and
(5) notifying, by the cyber shopping mall server, the users of the operations of the cyber shops applied for opening by the users by utilizing the cyber shop information of lower and upper layers interconnecting the cyber shops and the databases.

6. The hierarchical operation method as claimed in claim 5, wherein the cyber shops can share for use members information and goods information built by the cyber shops of lower and upper layers.

7. The hierarchical operation method as claimed in claim 5, wherein the upper-layer cyber shops can use the goods information of the lower-layer cyber shops and deal with corresponding goods.

8. The hierarchical operation method as claimed in claim 5, wherein the meta data includes, information for operating the cyber shopping mall such as the cyber shop classification criteria, requirements by field, code-granting method, database-constructing method, and so on.

9. The hierarchical operation method as claimed in claim 6, wherein the meta data includes information for operating the cyber shopping mall such as the cyber shop classification criteria, requirements by field, code-granting method, database-constructing method, and so on.

10. The hierarchical operation method as claimed in claim 7, wherein the meta data includes information for operating the cyber shopping mall such as the cyber shop classification criteria, requirements by field, code-granting method, database-constructing method, and so on.

11. A computer-readable recording medium of storing programs for realizing functions, in an information communication system having a processor, of:
(1) receiving cyber shop opening application information in a cyber shopping mall from users who wish to operate cyber shops;
(2) selecting hierarchical categories to which the cyber shops belong by using the cyber shop opening application information and existing shop information based on classification criteria defined by meta data for operating the cyber shopping mall;
(3) granting codes to the cyber shops and interconnecting upper and lower layers through databases with reference to the meta data based on the hierarchical categories of the cyber shops selected; and
(4) notifying the users of the operations of the cyber shops applied for opening by the users by utilizing the cyber shop information of lower and upper layers interconnecting the cyber shops and the databases.
